(19) United States
(12) Patent Application Publication
(10) Pub. No.: US 2026/0301009 A1
(43) Pub. Date: Oct. 1, 2026

(54) LOW-LATENCY ACCELERATOR AND LOW-LATENCY ACCELERATION METHOD

(71) Applicants: Chung Yuan Christian University, Taoyuan City (TW); KGI Securities Co. Ltd., Taipei City (TW)

(72) Inventors: Yu-Kuen Lai, Taoyuan City (TW); Chao-Lin Wang, Taipei City (TW); Po-Hsun Huang, Changhua County (TW)

(73) Assignees: Chung Yuan Christian University, Taoyuan City (TW); KGI Securities Co. Ltd., Taipei City (TW)

(21) Appl. No.: 19/257,515

(22) Filed: Jul. 2, 2025

(30) Foreign Application Priority Data
Apr. 1, 2025 (TW) 114112657

(51) Int. Cl. G06Q 30/0202; G06Q 40/06

(52) U.S. Cl. CPC G06Q 30/0202; G06Q 40/062

(57) ABSTRACT

A low-latency accelerator and a low-latency acceleration method are provided. The low-latency acceleration method comprises the following steps: receiving market information and parsing the market information via a first transmission protocol parser to generate a market information message; receiving transaction information and parsing the transaction information via a second transmission protocol parser to generate a transaction message; parsing the market information message using a market information parser to extract a plurality of product names and a plurality of corresponding product prices; parsing the transaction message using transaction information parser to determine a type of the transaction message and to extract corresponding transaction data; updating at least one table based on the transaction data via an order book management circuit; and generating and outputting margin information using a margin calculator, wherein the margin information is generated based on a plurality of tables, the extracted product names and the corresponding product prices.

### CROSS-REFERENCE TO RELATED APPLICATION

This application claims the priority benefit of Taiwan application serial no. 114112657, filed on Apr. 1, 2025. The entirety of the above-mentioned patent application is hereby incorporated by reference herein and made a part of this specification.

### BACKGROUND

### Technical Field

The disclosure relates to the field of financial trading systems, and more particularly to a low-latency accelerator and a low-latency acceleration method for processing trading-related data.

### Description of Related Art

With the development of computer automation, users increasingly conduct financial transactions through electronic devices, and the proportion of high-frequency trading (HFT) continues to grow annually. Generally, high-frequency trading relies on capturing minimal price spreads that appear momentarily in the trading market, requiring response times faster than a few milliseconds. Therefore, improving the speed of high-frequency trading has become a critical challenge that those skilled in the art urgently seek to address.

Conventional methods, for example, parse transaction information in high-frequency trading through a specific network interface card and/or software. However, in the process of data transmission, operating system scheduling, network stack processing, and characteristics of peripheral component interconnect express (PCIe) buses all generate delays of tens of microseconds, making it difficult to meet the demands of high-frequency trading. On the other hand, in order to address the above-mentioned high-latency issue, another method, for example, is to parse transaction information in high-frequency trading through an application specific integrated circuit (ASIC). Although the application specific integrated circuit has characteristics of high performance and low-latency, it has disadvantages such as long development cycles, high costs, and lack of scalability, thus still having limited improvements for high-frequency trading.

### SUMMARY

In view of this, the disclosure provides a low-latency accelerator and a low-latency acceleration method, capable of rapidly parsing a market information and a transaction information through a highly scalable field programmable gate array (FPGA), and calculating a margin information in real time, to enhance a speed of high-frequency trading.

A low-latency accelerator of the disclosure is disposed in a transaction server. The low-latency accelerator includes a first transmission protocol parser, a second transmission protocol parser, a market information parser, a transaction information parser, an order book management circuit, and a margin calculator. The order book management circuit stores a plurality of tables. The first transmission protocol parser receives a market information and parses the market information to generate a market information message. The second transmission protocol parser receives a transaction information and parses the transaction information to generate a transaction message. The market information parser parses the market information message to obtain a plurality of product names and a plurality of corresponding product prices thereof. The transaction information parser parses the transaction message to obtain a type of the transaction message and a transaction data. The order book management circuit updates at least one of the plurality of tables according to the transaction data. The margin calculator generates a margin information based on the plurality of tables, the plurality of product names, and the plurality of corresponding product prices, and outputs the generated margin information.

A low-latency acceleration method of the disclosure includes the following steps. A market information is received via a first transmission protocol parser, which parses the received market information to generate a market information message. A transaction information is received via a second transmission protocol parser, and the transaction information is parsed to generate a transaction message. The market information message is parsed by a market information parser to extract a plurality of product names and a plurality of corresponding product prices associated therewith. The transaction message is parsed by a transaction information parser to obtain a type of the transaction message and a to extract corresponding transaction data. A plurality of tables is maintained by an order book management circuit. At least one of the plurality of tables is updated based on the transaction data via the order book management circuit. A margin information is generated based on the plurality of tables, the plurality of product names, and the plurality of product prices through a margin calculator. The margin information is output.

In view of the foregoing, the present disclosure provides the low-latency accelerator and the low-latency acceleration method. By employing the low-latency accelerator implemented using a highly scalable field programmable gate array (FPGA), the market information and the transaction information can be rapidly parsed, and the margin information can be calculated in real time. This significantly improves the processing speed associated with high-frequency trading operations.

To make the features and advantages of the disclosure more comprehensible, several embodiments accompanied with drawings are described in detail as follows.

### BRIEF DESCRIPTION OF THE DRAWINGS

FIG. 1 illustrates a schematic diagram of a futures trading system according to an embodiment of the disclosure.

FIG. 2 illustrates a schematic diagram of a low-latency accelerator according to an embodiment of the disclosure.

FIG. 3 illustrates a schematic diagram of a market information parser according to an embodiment of the disclosure.

FIG. 4 illustrates a schematic diagram of a transaction information parser according to an embodiment of the disclosure.

FIG. 5 illustrates a flowchart of a low-latency acceleration method according to an embodiment of the disclosure.

### DESCRIPTION OF THE EMBODIMENTS

Some of the exemplary embodiments of the disclosure will be described in detail with the accompanying drawings. The reference numerals used in the following description will be regarded as the same or similar components when the same reference numerals appear in different drawings. These exemplary embodiments are only a part of the disclosure, and do not disclose all of the ways in which this disclosure can be implemented. More specifically, these exemplary embodiments are only examples of the device and method in the claims of the disclosure.

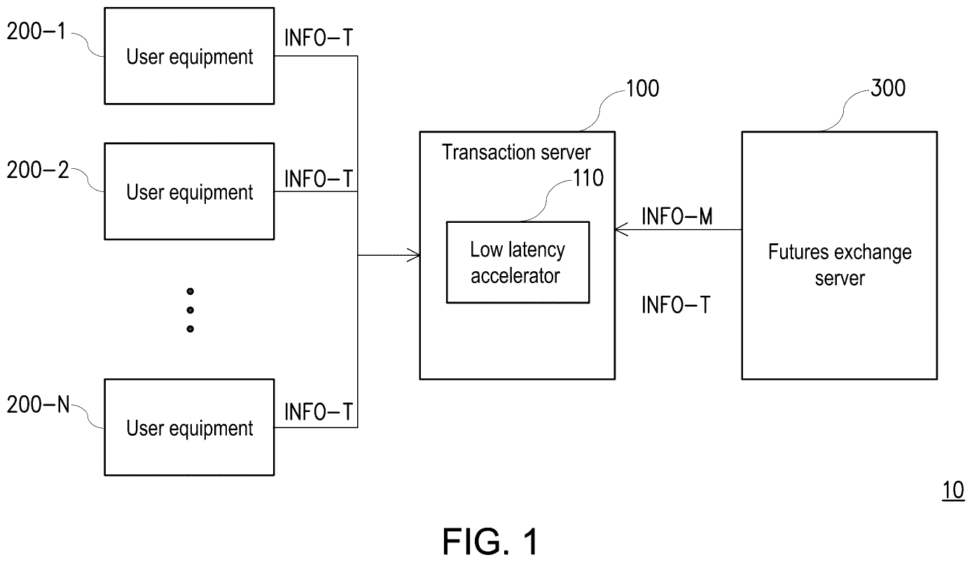

FIG. 1 illustrates a schematic diagram of a futures trading system according to an embodiment of the disclosure. Referring to FIG. 1, a futures trading system 10 includes a transaction server 100, user equipment 200-1~200-N, and a futures exchange server 300. A value of N may be adjusted according to actual requirements, and the disclosure does not limit thereto. A low-latency accelerator 110 is disposed in the transaction server 100. The futures exchange server 300, for example, belongs to a financial trading platform of a futures broker.

The user equipment 200-1~200-N, for example, are devices with computing capabilities, such as personal computers, notebook computers, smartphones, tablets, servers, or wearable devices, having a processor, a communication device (for example, various communication chips, Bluetooth chips, or Wi-Fi chips), and a storage device (for example, random access memory, flash memory, or hard disks), etc., and the disclosure is not limited thereto. A user (or a futures broker) may, for example, perform order operations of financial products such as stocks, futures, or securities through the user equipment 200-1~200-N.

The futures exchange server 300, for example, includes necessary components for operating the futures exchange server 300, such as a processing unit (for example, a processor, but not limited thereto), a communication unit (for example, various communication chips, mobile communication chips, Bluetooth chips, WiFi chips, etc., but not limited thereto), and a storage unit (for example, removable random access memory, flash memory, hard disks, etc., but not limited thereto), etc. The futures exchange server 300, for example, belongs to a financial trading platform of a futures exchange (for example, the Taiwan Futures Exchange).

In an embodiment, data and/or signal transmission between the transaction server 100, the user equipment 200-1~200-N, and the futures exchange server 300, for example, is performed through a network (not illustrated). For example, the transaction server 100, the user equipment 200-1~200-N, and the futures exchange server 300 may respectively have one or more Ethernet RJ45 connectors and small form-factor pluggable transceivers (SFP) configured to perform data and/or signal transmission.

In an embodiment, the transaction server 100, the user equipment 200-1~200-N, and the futures exchange server 300, for example, include a wireless communication module and support one of the wireless fidelity (Wi-Fi) systems, third-generation wireless communication technology (3G), fourth-generation wireless communication technology (4G), fifth-generation wireless communication technology (5G) or newer-generation wireless communication technology and Long Term Evolution (LTE) communication technology or a combination thereof, and are not limited thereto. In addition, the transaction server 100, the user equipment 200-1~200-N, and the futures exchange server 300 may also include a network interface card (NIC) to establish a network connection, thus enabling the transaction server 100, the user equipment 200-1~200-N, and the futures exchange server 300 to connect to a local area network or the Internet.

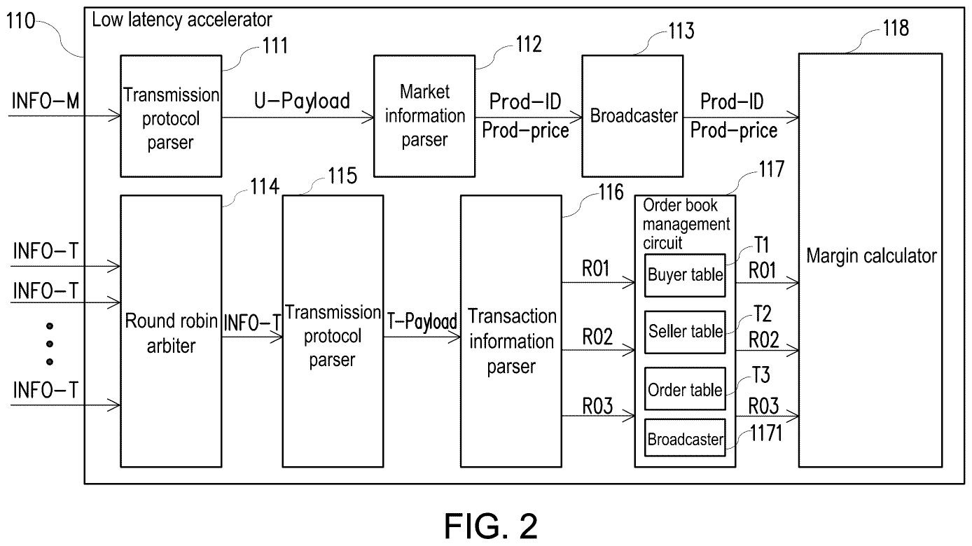

FIG. 2 illustrates a schematic diagram of a low-latency accelerator according to an embodiment of the disclosure. Referring to FIG. 2, the low-latency accelerator 110, for example, may be a field programmable gate array (FPGA) or other programmable logic circuit. According to design requirements, the low-latency accelerator 110 may include, but is not limited to, a transmission protocol parser 111 (also referred to as a first transmission protocol parser), a market information parser 112, a broadcaster 113, a round robin arbiter 114, a transmission protocol parser 115 (also referred to as a second transmission protocol parser), a transaction information parser 116, an order book management circuit 117, and a margin calculator 118. In an embodiment, an external host (not illustrated) may form the low-latency accelerator 110 by combining the transmission protocol parser 111, the market information parser 112, the broadcaster 113, the round robin arbiter 114, the transmission protocol parser 115, the transaction information parser 116, the order book management circuit 117, and the margin calculator 118, which are logic circuits described in a hardware description language (Verilog or VHDL), through logic synthesis and placement, routing and/or other operations via a control platform. The control platform, for example, is a NetFPGA SUME development platform, and the disclosure does not limit thereto.

In an exemplary embodiment, data and/or signals transmitted in the low-latency accelerator 110, for example, are transmitted using an AXI (Advanced eXtensible Interface) bus protocol or other transmission protocols. The AXI bus protocol is a bus communication protocol characterized by low latency, high performance, and high bandwidth, and is well-suited to meet the design requirements of System-on-Chip (SoC) architectures. Specifically, when data and/or signals are transmitted by the AXI bus protocol, the data and/or signals are segmented into multiple packets transmitted in units of 32 bytes. Generally, in the AXI bus protocol, an operation frequency of a data path (for example, AXI4-Stream) for packet data stream transmission is 250 (MHz), and an operation frequency of a control path (for example, AXI4-Lite) for reading and writing registers (not illustrated) inside the low-latency accelerator 110 is 100 (MHz).

Referring to FIG. 1 and FIG. 2 at the same time, a user (or futures broker) may perform an order operation through the user equipment 200-1~200-N, and a transaction information INFO-T corresponding to the order operation may be transmitted to the low-latency accelerator 110 in the transaction server 100 to calculate margin corresponding to this order operation. In addition, the futures exchange server 300 may also provide a market information INFO-M and/or the transaction information INFO-T corresponding to a report operation to the low-latency accelerator 110. Specifically, the user equipment 200-1~200-N and the futures exchange server 300 transmit the transaction information INFO-T based on the Transmission Control Protocol (TCP), and the futures exchange server 300 transmits the market information INFO-M based on the User Datagram Protocol (UDP).

The transmission protocol parser 111 may be configured to parse data packets adopting a User Datagram Protocol (UDP) standard. For example, the transmission protocol parser 111 may parse the market information INFO-M received from the futures exchange server 300, and provide the parsed market information message U-Payload to the market information parser 112. Specifically, the transmission protocol parser 111 adopts a pipeline design to reduce latency. Further, in the AXI bus protocol, the market information INFO-M may be segmented into multiple packets of 32 bytes, and adopting the pipeline design may shorten the time required to parse each packet, so as to reduce processing latency.

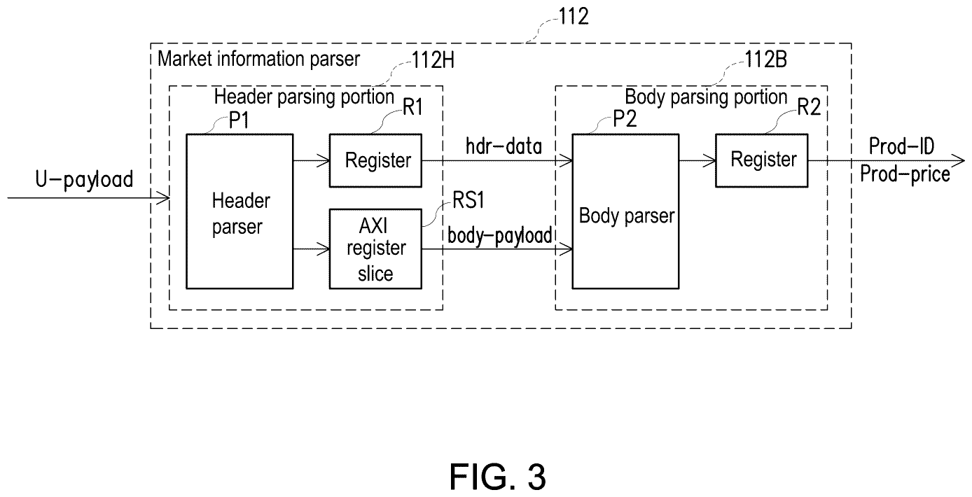

The market information parser 112 may be configured to parse the market information message U-Payload to obtain a plurality of product names Prod-ID and a plurality of corresponding product prices Prod-price. Specifically, referring to FIG. 3, FIG. 3 illustrates a schematic diagram of a market information parser according to an embodiment of the disclosure. In the embodiment, the market information parser 112 adopts a two-stage pipeline design to reduce latency. The market information parser 112 may include a header parsing portion 112H and a body parsing portion 112B. The header parsing portion 112H includes a header parser P1, a register R1, and an AXI register slice RS1. The body parsing portion 112B includes a body parser P2 and a register R2.

The market information message U-Payload, for example, may include a standard header and a message body. The header parser P1, as the name implies, is configured to parse a header data hdr-data, of the market information message U-Payload. The header parser P1 may temporarily buffer the parsed header data hdr-data in the register R1.

The AXI register slice RS1 is configured to adjust or align the operation timing of the market information parser 112. The header parser P1 may transmit the message body body-Payload, of the market information message U-Payload to the AXI register slice RS1 at an appropriate timing, for example, when the body parsing portion 112B is in an idle state. Subsequently, the AXI register slice RS1 and the register R1 respectively provide the message body body-Payload and the header data hdr-data to the body parser P2.

The body parser P2 may parse the corresponding product names Prod-ID and the product prices Prod-Price according to the message body body-Payload and the header data hdr-data, and temporarily buffer the parsed product names Prod-ID and product prices Prod-Price into the register R2. After all the product names Prod-ID and their corresponding product prices Prod-Price within the market information message U-Payload have been parsed, the register R2 transmits the parsed product names Prod-ID and the product prices Prod-Price to the broadcaster 113.

The broadcaster 113, for example, may broadcast the plurality of product names Prod-ID and the plurality of product prices Prod-Price received from the market information parser 112 to the margin calculator 118.

On the other hand, the round robin arbiter 114 may be configured to determine a priority order for processing. For example, the round robin arbiter 114 may establish the priority order based on the chronological order in which data and/or messages are received. In accordance with the determined priority, the round robin arbiter 114 may provide the transaction information INFO-T to the order information parser. Additionally, the round robin arbiter 114 may transmit the earliest received transaction information INFO-T to the transmission protocol parser 115.

The transmission protocol parser 115 may be configured to parse data packets that conform to the Transmission Control Protocol (TCP) standard. For example, the transmission protocol parser 115 may parse the transaction information INFO-T received from the round robin arbiter 114, and provide a parsed transaction message T-Payload to the transaction information parser 116. The transmission protocol parser 115 is implemented using a pipeline architecture, similar to the transmission protocol parser 111, in order to reduce processing latency.

It should be noted that, although the low-latency accelerator 110 of FIG. 2 includes only the transmission protocol parser 111 for parsing data and/or signals adopting a UDP standard and the transmission protocol parser 115 for parsing data and/or signals adopting a TCP standard, the low-latency accelerator 110 implemented using a field-programmable gate array (FPGA) exhibits high scalability. Accordingly, parsers for additional transmission protocols may be flexibly programmed into the low-latency accelerator 110 via the aforementioned control platform.

The transaction information parser 116 may be configured to parse the transaction message T-Payload to extract the message type and transaction data R01, R02 or R03 of the transaction message T-Payload. In one embodiment, the type of the transaction message T-Payload may include, but is not limited to, an order input message, an order report message, or an error report message, each conforming to the Taifex Message Protocol (TMP) specification.

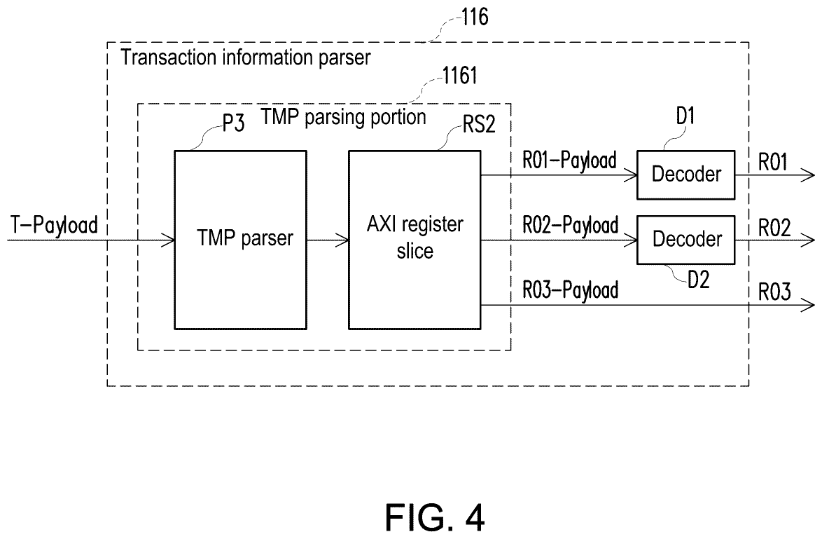

Specifically, referring to FIG. 4, FIG. 4 illustrates a schematic diagram of a transaction information parser according to an embodiment of the disclosure. In the embodiment, the transaction information parser 116 may include a TMP parsing portion 1161, a decoder D1, and a decoder D2. The TMP parsing portion 1161 includes a TMP parser P3 and an AXI register slice RS2.

The TMP parser P3 may be configured to parse the transaction message T-Payload and , based on the message type, transmit a corresponding parsed message R01-Payload, R02-Payload, or R03-Payload to the AXI register slice RS2 at an appropriate time. For example, if the type of the transaction message T-Payload is identified as an order input message, and the decoder D1 is in an idle state, the TMP parser P3 may transmit the message R01-Payload to the AXI register slice RS2, which then provides it to the decoder D1. The decoder D1 may decode the message R01-Payload to extract transaction data R01. Similarly, if the type of the transaction message T-Payload is an order report message, and the decoder D2 is in the idle state, the TMP parser P3 may transmit the message R02-Payload to the AXI register slice RS2, which then provides it to the decoder D2. The decoder D2 may decode the message R02-Payload to obtain the transaction data R02. Additionally, if the type of the transaction message T-Payload is an error report message, when the order book management circuit 117 is in the idle state, the TMP parser P3 may transmit the message R03-Payload to the AXI register slice RS2, which subsequently provides the message R03-Payload (i.e., the transaction data R03) to a broadcaster 1171 within the order book management circuit 117.

The order book management circuit 117 stores a buyer table T1, a seller table T2, and an order table T3. The order book management circuit 117, for example, updates the buyer table T1 and/or the seller table T2 and/or the order table T3 according to the received transaction data R01 (and/or the transaction data R02 or the transaction data R03). In this embodiment, the buyer table T1 may include, but is not limited to, a buyer order lot quantity, a buyer filled lot quantity, and an accumulated buyer order lot quantity. The seller table T2 may include, but is not limited to, a seller order lot quantity, a seller filled lot quantity, and an accumulated seller order lot quantity. The order table T3 may include, but is not limited to, an order number, a buy/sell type, an order lot quantity, an order price, and an investor account.

The margin calculator 118 may be configured to generate and output margin information based on the most recent tables T1~T3 maintained in the order book management circuit 117 and the plurality of product names Prod-ID and the plurality of product prices Prod-price received from the broadcaster 113. In this embodiment, the margin calculator 118 may compute the margin required for transactions involving index futures, stock futures, and/or index option associated with an order operation performed by a user (or futures broker). This calculation is based on the updated tables T1~T3 and the product names Prod-ID and the product prices Prod-price) reflecting current market conditions. The margin calculator 118 integrates the calculated margin and related transactional data into comprehensive margin information, and subsequently outputs the margin information to a device, such as user equipment 200-1 operated by this user (or futures broker) executing the order operation.

In view of the foregoing, the low-latency accelerator 110 may rapidly parse transaction order information (i.e., the transaction information INFO-T from user equipment 200-1~200-N), transaction report information (i.e., transaction information INFO-T originating from the futures exchange server 300), and market information INFO-M. Based on the parsing results, the tables T1~T3 may be immediately updated, thereby enabling real-time margin calculation. This functionality significantly reduces processing delays and enhances the execution speed of high-frequency trading operations.

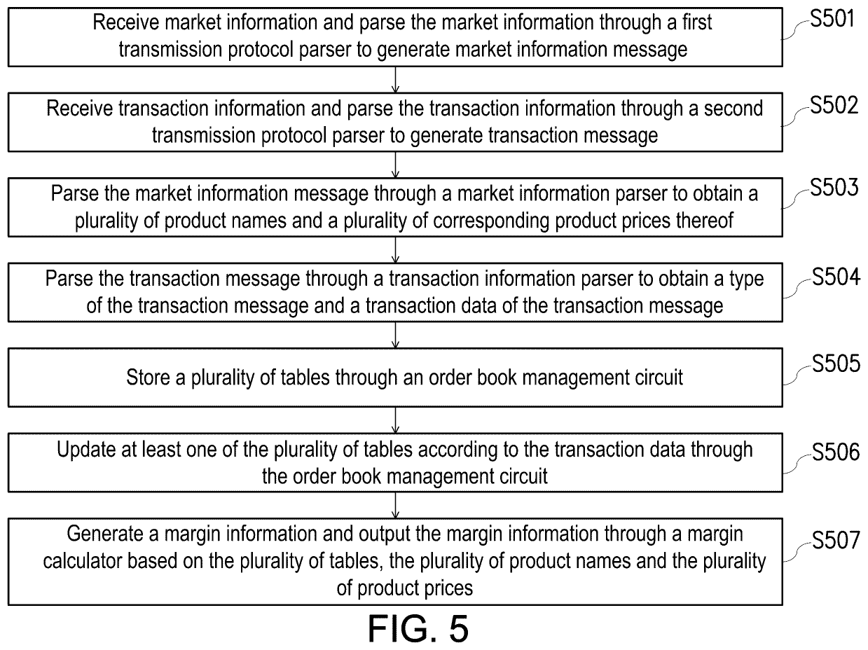

FIG. 5 illustrates a flowchart of a low-latency acceleration method according to an embodiment of the disclosure, wherein the low-latency acceleration method may be implemented by the low-latency accelerator 110 as shown in FIG. 1. Referring to FIG. 1 and FIG. 5, in step S501, the market information INFO-M is received through the first transmission protocol parser 111, and the market information INFO-M is parsed to generate a market information message U-Payload. In step S502, the transaction information INFO-T is received through the second transmission protocol parser 115. The received transaction information INFO-T is parsed to generate a corresponding transaction message T-Payload. In step S503, the market information message U-Payload is parsed through the market information parser 112 to obtain a plurality of product names Prod-ID and a plurality of corresponding product prices Prod-price thereof. In step S504, the transaction message T-Payload is parsed by the transaction information parser 116 to obtain a type of the transaction message and a transaction data R01 and/or the transaction data R02 or R03. In step S505, a plurality of tables T1~T3 is stored through the order book management circuit 117. In step S506, at least one of the plurality of tables T1~T3 is updated through the order book management circuit 117 according to the transaction data R01, R02 or R03. In step S507, a margin information is generated through the margin calculator 118 based on the plurality of tables T1~T3, the plurality of product names Prod-ID, and the plurality of product prices Prod-price. The margin information is then output for use, for example, by user equipment or trading systems.

In summary, the low-latency accelerator and the low-latency acceleration method disclosed herein utilize a highly scalable and low-latency field programmable gate array (FPGA) circuit to rapidly parse transaction order information, transaction report information, and market information. Based on the parsing results, the system can instantly update the order book, including the buyer table, seller table, and order table. This enables rapid calculation of the margin required for futures trading, thereby significantly reducing the time required for executing high-frequency trading operations.

Although the present disclosure has been described with reference to the foregoing embodiments, these embodiments are provided for illustrative purposes only and are not intended to limit the scope of the disclosure. It will be apparent to those skilled in the art that various modifications may be made to the described embodiments without departing from the spirit and scope of the disclosure. Accordingly, the scope of the disclosure will be defined by the attached claims and their equivalents and not by the above detailed descriptions.

What is claimed is:

1. A low-latency accelerator, disposed in a transaction server, the low-latency accelerator comprising:
a first transmission protocol parser, configured to receive a market information and parse the market information to generate a market information message;
a second transmission protocol parser, configured to receive a transaction information and parse the transaction information to generate a transaction message;
a market information parser, configured to parse the market information message to obtain a plurality of product names and a plurality of corresponding product prices thereof;
a transaction information parser, configured to parse the transaction message to obtain a type of the transaction message and a transaction data;
an order book management circuit, storing a plurality of tables and configured to update at least one of the plurality of tables according to the transaction data; and
a margin calculator, configured to generate a margin information based on the plurality of tables, the plurality of product names, and the plurality of product prices, and to output the margin information.

2. The low-latency accelerator according to claim 1, wherein the low-latency accelerator further comprises:
a round robin arbiter, configured to determine a priority order and provide the transaction information to the second transmission protocol parser based on the priority order.

3. The low-latency accelerator according to claim 1, wherein the low-latency accelerator further comprises:
a broadcaster, coupled to the market information parser and configured to broadcast the plurality of product names and the plurality of product prices to the margin calculator.

4. The low-latency accelerator according to claim 1, wherein the type is an order input message, an order report message, or an error report message.

5. The low-latency accelerator according to claim 1, wherein the plurality of tables are respectively a buyer table, a seller table, or an order table.

6. The low-latency accelerator according to claim 5, wherein the order table comprises an order number, a buy/sell type, an order lot quantity, an order price, and an investor account.

7. The low-latency accelerator according to claim 5, wherein the buyer table comprises a buyer order lot quantity, a buyer filled lot quantity, and an accumulated buyer order lot quantity.

8. The low-latency accelerator according to claim 5, wherein the seller table comprises a seller order lot quantity, a seller filled lot quantity, and an accumulated seller order lot quantity.

9. The low-latency accelerator according to claim 1, wherein the first transmission protocol parser, the second transmission protocol parser, and the market information parser adopt a pipeline design.

10. A low-latency acceleration method, comprising:
receiving a market information through a first transmission protocol parser and parsing the market information to generate a market information message;
receiving a transaction information through a second transmission protocol parser and parsing the transaction information to generate a transaction message;
parsing the market information message through a market information parser to obtain a plurality of product names and a plurality of corresponding product prices thereof;
parsing the transaction message through a transaction information parser to obtain a type of the transaction message and a transaction data;
storing a plurality of tables through an order book management circuit;
updating at least one of the plurality of tables according to the transaction data through the order book management circuit; and
generating a margin information based on the plurality of tables, the plurality of product names, and the plurality of product prices through a margin calculator, and outputting the margin information.
